(19) United States
(12) Patent Application Publication
(10) Pub. No.: US 2026/0360900 A1
(43) Pub. Date: Nov. 12, 2026

(54) BATTERY PACK STRUCTURE FOR VEHICLE

(71) Applicant: Nissan Motor Co., Ltd., Kanagawa (JP)

(72) Inventors: Genki Nanaumi, Kanagawa (JP); Yuki Shigeta, Kanagawa (JP); Yusuke Nagaishi, Kanagawa (JP)

(73) Assignee: Nissan Motor Co., Ltd., Kanagawa (JP)

(21) Appl. No.: 19/135,232

(22) PCT Filed: Dec. 9, 2022
(86) PCT No.: PCT/JP2022/045542

§ 371 Date: Jun. 3, 2025

(51) Int. Cl. H01M 50/249; H01M 50/227; H01M 50/229; H01M 50/231; H01M 50/342

(52) U.S. Cl. CPC H01M 50/249; H01M 50/227; H01M 50/229; H01M 50/231; H01M 50/342

(57) ABSTRACT

A battery pack structure for a vehicle includes a housing that is configured to house a battery; and a wall that is configured to form at least a part of the housing and cover the battery. The wall includes a first layer that is configured to form a portion of the wall on one side in a thickness direction of the wall, and a second layer that is formed on the other side of the first layer in the thickness direction of the wall. The first layer and the second layer each contain a reinforcing fiber and a flame retardant. A content ratio of the reinforcing fiber of the first layer in the first layer is higher than a content ratio of the reinforcing fiber of the second layer in the second layer. A content ratio of the flame retardant of the first layer in the first layer is lower than a content ratio of the flame retardant of the second layer in the second layer.

### TECHNICAL FIELD

The present invention relates to a battery pack structure for a vehicle.

### BACKGROUND

A battery pack housing for an electric vehicle disclosed in Patent Literature 1 is a cured product of a molding material containing an unsaturated polyester resin composition and reinforcing fibers. The unsaturated polyester resin composition contains an unsaturated polyester, a polymerizable monomer, a reduced-shrinkage agent, aluminum hydroxide, and a conductive filler. The unsaturated polyester is a polymerization product of a polybasic acid containing a polybasic acid having a predetermined rate of an ethylenically unsaturated double bond and a polyhydric alcohol. Polyvinyl acetate, which is a shrink reducing agent, is in a predetermined ratio to the total amount of unsaturated polyester, polymerizable monomer and shrink reducing agent. Aluminum hydroxide is in a predetermined ratio to the total amount of unsaturated polyester, polymerizable monomer and shrink reducing agent.

### CITATION LIST

### Patent Literature

Patent Literature 1: WO 2020/162288 A1

### SUMMARY OF THE INVENTION

### Technical Problem

In the meantime, when a battery cell disposed in the housing of a battery pack for a vehicle releases a high-temperature gas, the pressure inside the housing increases due to the emission of the gas, and thus there is a possibility that a relatively high pressure is input into the housing from the inside. Further, the temperature of the housing may increase due to the heat of the gas.

An object of the present invention is to improve the rigidity and heat resistance of a housing of a battery pack for a vehicle when a battery cell releases gas.

### Technical Solution

A battery pack structure for a vehicle according to an aspect of the present invention includes a housing, and a wall that is configured to form at least a part of the housing, in which the wall includes a first layer and a second layer, the first layer and the second layer contain a reinforcing fiber and a flame retardant, a content ratio of the reinforcing fiber of the first layer in the first layer is higher than a content ratio of the reinforcing fiber of the second layer in the second layer, and a content ratio of the flame retardant of the first layer in the first layer is lower than a content ratio of the flame retardant of the second layer in the second layer.

### Advantageous Effects

The present invention makes it possible to improve the rigidity and heat resistance of a housing of a battery pack for a vehicle when a battery cell releases gas.

### BRIEF DESCRIPTION OF DRAWINGS

FIG. 1 is a perspective view illustrating an example of the overall configuration of a battery pack to which a battery pack structure for a vehicle according to a first embodiment is applied.

FIG. 2 is a schematic perspective view of battery cells of the battery pack structure for a vehicle according to the first embodiment.

FIG. 3 is an exploded perspective view of the battery pack to which the battery pack structure for a vehicle according to the first embodiment is applied.

FIG. 4 is a diagram illustrating a positional relationship between an opposing wall and a battery module of the battery pack structure for a vehicle according to the first embodiment, and is a schematic cross-sectional view of the battery pack structure for a vehicle taken along the line IV-IV of FIG. 1.

FIG. 5 is a graph illustrating an example of the distribution of a content ratio of a reinforcing fiber and a flame retardant in the opposing wall of the battery pack structure for a vehicle according to the first embodiment.

FIG. 6 is a graph illustrating an example of the distribution of a content ratio of the reinforcing fiber and the flame retardant in the opposing wall of the battery pack structure for a vehicle according to the first embodiment.

FIG. 7 is a diagram illustrating a positional relationship between a first wall and a battery module of a battery pack structure for a vehicle according to a second embodiment, and is a schematic cross-sectional view of the battery pack structure for a vehicle corresponding to FIG. 4.

FIG. 8 is a graph illustrating an example of the distribution of a content ratio of a reinforcing fiber and a flame retardant in the first wall of the battery pack structure for a vehicle according to the second embodiment.

FIG. 9 is a graph illustrating an example of the distribution of a content ratio of the reinforcing fiber and the flame retardant in the first wall of the battery pack structure for a vehicle according to the second embodiment.

FIG. 10 is a diagram explaining a wall of a battery pack structure for a vehicle according to a third embodiment, and is a schematic diagram illustrating a main portion of a cross section of the battery pack structure for a vehicle corresponding to FIG. 4.

FIG. 11 is a graph illustrating an example of the distribution of a content ratio of a reinforcing fiber and a flame retardant in the wall of the battery pack structure for a vehicle according to the third embodiment.

FIG. 12 is a graph illustrating an example of the distribution of a content ratio of the reinforcing fiber and the flame retardant in the wall of the battery pack structure for a vehicle according to the third embodiment.

### DESCRIPTION OF EMBODIMENTS

Hereinafter, a battery pack structure for a vehicle according to an embodiment will be described with reference to the drawings. In each figure, FR and RR denote a front side and a rear side in a vehicle front-rear direction respectively. LH and RH denote a left side and a right side in a vehicle width direction respectively. UP and DN denote an upper side and a lower side in a vehicle up-down direction respectively. In the following description, the left side and the right side in the vehicle width direction, and the front side and the rear side in the vehicle front-rear direction are simply called “vehicle left side”, “vehicle right side”, “upper side/upward”, and “lower side/downward”, respectively. In the following description, the elements having the same function are denoted by the same reference numerals, and a description thereof will be omitted.

The battery pack structure for a vehicle according to the embodiment can be used, for example, in a power source for driving a vehicle that is an electric vehicle (not illustrated) driven by an electric motor. The vehicle is not limited to an electric vehicle, and the battery pack structure for a vehicle may be applied to a power source for driving mounted on a hybrid vehicle, for example.

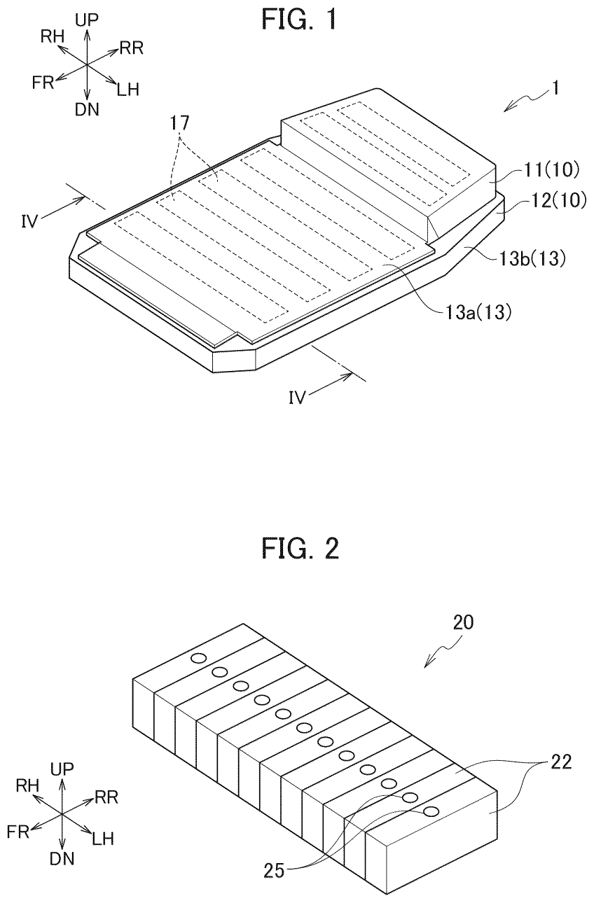

First, an example of the structure of a battery pack 1 as a battery pack for a vehicle will be described with reference to FIGS. 1 to 4. The battery pack 1 illustrated in FIG. 1 is a power source for driving a vehicle, and may be disposed on the lower side of a floor panel of a vehicle. The battery pack 1 includes a housing 10. The housing 10 is a member forming the exterior of the battery pack 1. In the illustrated example, the housing 10 houses a battery module 20, which will be described later, including one or more battery cells 22 as batteries (see FIG. 2). That is, one or more battery cells 22, which will be described later, are housed in the housing 10. The housing 10 may be a hollow member having a square box-shaped flat shape.

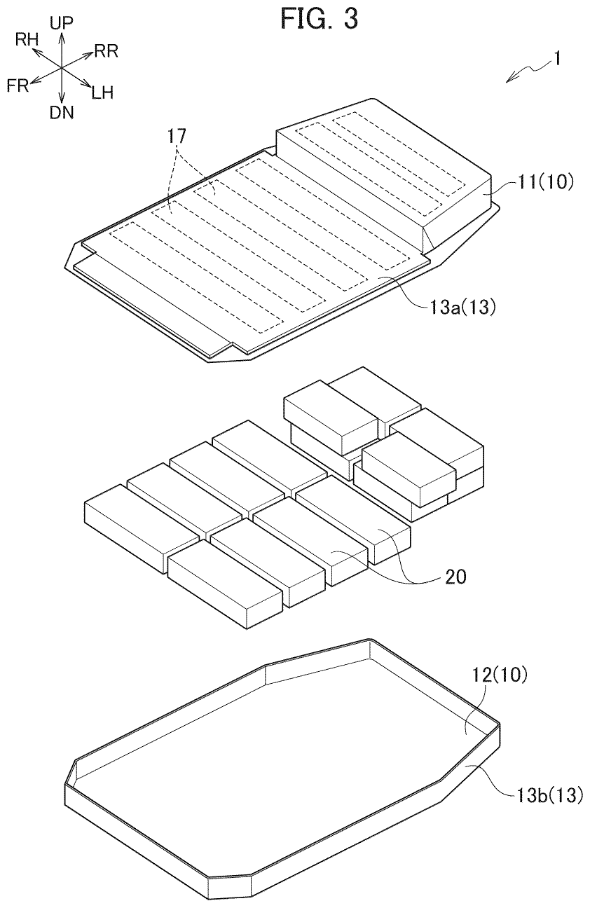

The housing 10 illustrated in the figures has a wall 13. The wall 13 forms at least a part of the housing 10 and surrounds the battery cells 22. The battery cells 22 are disposed in the region inward of the wall 13 (see FIG. 3). The inward direction of the wall 13 refers to the direction toward the internal space of the housing 10 in the thickness direction of the wall. The outward direction of the wall 13 refers to the direction opposite to the inward direction of the wall 13 in the thickness direction of the wall. The wall 13 may surround the battery modules 20 in the vehicle front-rear direction, the vehicle width direction, and the vehicle up-down direction. The wall 13 may also include a wall 13a and a wall 13b. The wall 13a forms at least a part of an upper cover 11 which will be described later. The wall 13b forms at least a part of a lower case 12 which will be described later. The shape of the housing 10 is not limited to the illustrated example, and can be appropriately set according to the shape and dimensions of the battery pack 1, how the battery pack 1 is disposed in the vehicle, or the like.

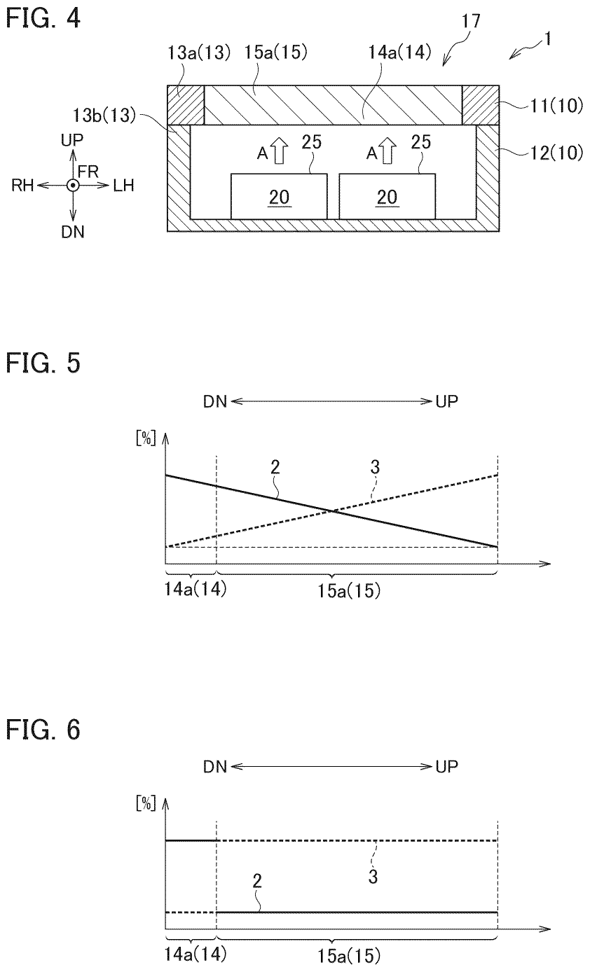

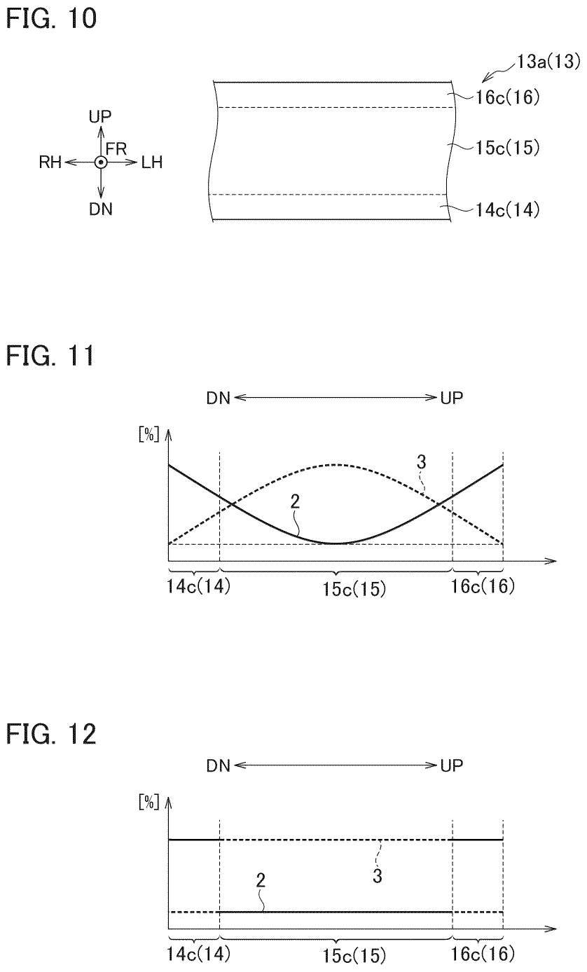

The wall 13 includes a first layer 14 and a second layer 15 (see FIGS. 4, 7, and 10). The wall 13 may also include a third layer 16 which will described later (see FIG. 10). However, the configuration of the wall 13 is not limited to the illustrated example. For example, another layer may be formed in the region of the first layer 14 opposite to the second layer 15. In addition, another layer may be formed in the region of the second layer 15 opposite to the first layer 14. In addition, another layer may be formed in the region of the third layer 16 opposite to the second layer 15.

The first layer 14 forms a portion on one side in the thickness direction of the wall 13. The second layer 15 is formed on the other side of the first layer 14 in the thickness direction of the wall 13. In addition, the third layer 16 may be formed on the other side of the second layer 15 in the thickness direction of the wall 13. In the example illustrated in FIG. 4, the first layer 14 forms a lower portion in the thickness direction of the wall 13. The second layer 15 forms an upper potion in the thickness direction of the wall 13. In the illustrated example, the wall 13 is formed such that the first layer 14 and the second layer 15 are directly adjacent to each other; however, the present invention is not limited thereto. For example, one or more other layers may be included between the first layer 14 and the second layer 15. That is, the first layer 14 and the second layer 15 may be indirectly adjacent to each other in the thickness direction of the wall 13. The one or more other layers are simply referred to as “intermediate layer(s)”.

In the example illustrated in FIG. 4, an inner layer 14a as the first layer 14 forms an inner portion of the wall 13a. Therefore, the inner layer 14a may define at least a part of the inner space of the housing 10. The inner layer 14a may also form a lower portion of the upper cover 11. An outer layer 15a as the second layer 15 forms an outer portion of the wall 13a. The outer layer 15a may form at least a part of the exterior surface of the housing 10. The outer layer 15a may form an upper portion of the upper cover 11. The thickness of the first layer 14 or the second layer 15 in the thickness direction of the wall 13 is not particularly limited, and may be set to about ⅓ of the thickness of the wall 13. For example, in one embodiment, the wall 13 may have a thickness of 1.5 mm to 6 mm, and the first layer 14 may have a thickness of 0.5 mm to 2 mm. In addition, the second layer 15 may have a thickness of 0.5 mm to 2 mm.

The housing 10 illustrated in FIG. 1 has an upper cover 11 and a lower case 12. The upper cover 11 and the lower case 12 may be fastened to each other at the periphery thereof by fasteners (not illustrated) such as bolts. The lower case 12 illustrated in FIG. 1 is a bottomed box-shaped member with an open upper portion in the vehicle, and has a substantially rectangular shape in plan view. The lower case 12 may be made of metal such as aluminum. A battery module 20 is disposed at the bottom of the lower case 12. The mode in which the battery module 20 is disposed in the lower case 12 is not limited to the illustrated example, and may be appropriately set according to the shape or dimensions of the battery pack 1, for example. In addition, a wiring member (not illustrated) such as a bus bar for electrically connecting the battery modules 20 to each other may be disposed inside the case 10. The upper cover 11 illustrated in the figures is a plate-like member having a substantially rectangular shape in plan view. The upper cover 11 may be made of resin, for example. The upper opening of the lower case 12 is closed by the upper cover 11, thereby sealing the inside of the housing 10. The shape of the upper cover 11 is not limited to the illustrated example, and may be appropriately set according to the shape of the battery pack 1, for example. As illustrated in FIG. 3, a plurality of battery modules 20 are housed in the housing 10; however, the present invention is not limited thereto. The number of battery modules 20 disposed in the housing 10 may be appropriately set according to the dimensions of the battery pack 1 or the battery module 20, for example.

The battery module 20 illustrated in FIG. 2 is a modular component in which multiple battery cells 22 are arranged in parallel. The battery cells 22 may be arranged in parallel in the vehicle width direction. The number of battery cells 22 included in the battery module 20 may be one. The battery module 20 may be provided with a modular case (not illustrated) which is an exterior member for integrally housing the plurality of battery cells 22. Each of the plurality of battery cells 22 is electrically connected to each other by a wiring member such as a bus bar unit (not illustrated). The battery cell 22 may be formed by sealing a power generation element and an electrolyte within a metal exterior member. The power generation element is composed of a positive electrode plate and a negative electrode plate laminated with a separator in between. The battery cell 22 may be a lithium ion secondary battery.

The battery cell 22 may have a gas release portion 25. When gas is generated inside the battery cell 22, the gas can be released from the gas release portion 25. The shape and structure of the gas release portion 25 are not particularly limited, and for example, the gas release portion 25 may include an explosion-proof valve that opens to release the gas when the internal pressure of the battery cell 22 exceeds a predetermined pressure, or a seal member that breaks to release the gas. The gas release portion 25 illustrated in FIG. 2 is formed on the upper portion of the battery cell 22.

The structure of the battery module 20 and the battery cell 22 is not limited to the illustrated example. For example, the battery module 20 may be a modular component in which one or more battery cells 22 are arranged in parallel in the up-down direction. The battery cell 22 may be formed by covering a plurality of laminated cells (not illustrated) which are electrically connected to each other with a metal exterior member. The laminated cell may be formed by sealing a power generation element and an electrolyte within a laminated film. The power generation element is composed of a positive electrode plate and a negative electrode plate laminated with a separator in between. The gas release portion 25 in the battery cell 22 may be positioned such that the gas can be released laterally from the battery module 20, for example.

Next, an example of the structure of the wall 13 will be described with reference to FIG. 4. Each of the first layer 14 and the second layer 15 provided in the wall 13 includes a reinforcing fiber 2 and a flame retardant 3. In the example illustrated in the figure, the wall 13a of the upper cover 11 includes the reinforcing fiber 2 and the flame retardant 3. The wall 13a may be formed by integrally molding the reinforcing fiber 2, the flame retardant 3, and resin. That is, the wall 13a may include the reinforcing fiber 2, the flame retardant 3, and resin. The resin forming the wall 13a is not particularly limited, and a known thermosetting resin may be used, for example. The thermosetting resin may be, for example, unsaturated polyester resin, phenol resin, melamine resin, polyurethane resin, epoxy resin, vinyl ester resin, or the like. By using the thermosetting resin as a resin component of the wall 13a, the heat resistance and rigidity of the wall 13a can be improved. In addition, a thermoplastic resin may be used as the resin forming the wall 13a. The thermoplastic resin may be, for example, polypropylene resin, polyethylene resin, polyamide resin, PEKK resin (polyether ketone ketone), or the like.

The reinforcing fiber 2 is composed of multiple fibers, and the fibers may be, for example, glass fibers, carbon fibers, boron fibers, aramid fibers, or the like. The fiber length and fiber diameter of the fibers are not particularly limited, and the fibers may be short fibers, long fibers, or continuous fibers. The orientation of the fibers within the wall 13a is not particularly limited. For example, multiple fibers may be bundled to form a reinforcing fiber bundle, and multiple reinforcing fiber bundles may be aligned and laminated in one direction or at different angles. Each of the multiple reinforcing fiber bundles may be bound together with stitching thread or retained in shape by heat fusion. The multiple fibers may constitute a fabric.

The flame retardant 3 is a substance for imparting flame retardancy to the wall 13a. The flame retardant 3 may be a filler dispersed in the wall 13a, and may be composed of a plurality of particles consisting of hydrated metal compounds such as aluminum hydroxide, magnesium hydroxide, calcium hydroxide. Thus, even if the temperature inside the housing 10 increases due to the gas released from the battery cell 22, the housing 10 can be cooled more reliably by the endothermic reaction of the hydrated metal compounds. In other words, the temperature increase of the housing 10 caused by the gas can be suppressed more reliably. The flame retardant 3 is not limited to these examples, and can be appropriately selected according to the material of the housing 10, the manufacturing method thereof, or the like.

The wall 13 containing the reinforcing fiber 2 and the flame retardant 3 is not limited to the wall 13a of the upper cover 11. For example, the wall 13b of the lower case 12 may be formed by integrally molding the reinforcing fiber 2, the flame retardant 3, and resin.

In the battery pack 1 according to the embodiment, a content ratio of the reinforcing fiber 2 of the first layer 14 is higher than a content ratio of the reinforcing fiber 2 of the second layer 15. Further, a content ratio of the flame retardant 3 of the first layer 14 is lower than a content ratio of the flame retardant 3 of the second layer 15. More specifically, a content ratio of the reinforcing fiber 2 of the first layer 14 in the first layer 14 is higher than a content ratio of the reinforcing fiber 2 of the second layer 15 in the second layer 15. Further, a content ratio of the flame retardant 3 of the first layer 14 in the first layer 14 is lower than a content ratio of the flame retardant 3 of the second layer 15 in the second layer 15. If the wall 13 includes an intermediate layer, content ratios of the reinforcing fiber 2 and the flame retardant 3 in the intermediate layer are not particularly limited. The intermediate layer may be the layer not containing the reinforcing fiber 2 and the flame retardant 3, for example, made of resin.

The intermediate layer may contain the reinforcing fiber 2 and the flame retardant 3. In one embodiment, a content ratio of the reinforcing fiber 2 of the intermediate layer may be lower than a content ratio of the reinforcing fiber 2 of the first layer 14, and higher than a content ratio of the reinforcing fiber 2 of the second layer 15. Further, a content ratio of the flame retardant 3 of the intermediate layer may be higher than a content ratio of the flame retardant 3 of the first layer 14, and lower than a content ratio of the reinforcing fiber 2 of the second layer 15. Thus, even if the wall 13 includes the intermediate layer, the rigidity of the wall 13 against a load in the direction perpendicular to the thickness direction can be improved as compared to, for example, the case in which the intermediate layer does not contain the reinforcing fiber 2 and the flame retardant 3.

The region of the intermediate layer on the first layer 14 side may be directly adjacent to the first layer 14. In this case, a content ratio of the reinforcing fiber 2 in the region of the intermediate layer on the first layer 14 side and a content ratio of the reinforcing fiber 2 in the region of the first layer 14 on the intermediate layer side may be approximately equal to each other. In addition, a content ratio of the flame retardant 3 in the region of the intermediate layer on the first layer 14 side and a content ratio of the flame retardant 3 in the region of the first layer 14 on the intermediate layer side may be approximately equal to each other. Thus, the adhesion between the first layer 14 and the intermediate layer can be further improved, thereby further improving the rigidity of the wall 13 against a load input from the direction perpendicular to the thickness direction.

In addition, the region of the intermediate layer on the second layer 15 side may be directly adjacent to the second layer 15. In this case, a content ratio of the reinforcing fiber 2 in the region of the intermediate layer on the second layer 15 side and a content ratio of the reinforcing fiber 2 in the region of the second layer 15 on the intermediate layer side may be approximately equal to each other. In addition, a content ratio of the flame retardant 3 in the region of the intermediate layer on the second layer 15 side, and a content ratio of the flame retardant 3 in the region of the second layer 15 on the intermediate layer side may be approximately equal to each other. Thus, the adhesion between the second layer 15 and the intermediate layer can be further improved, thereby further improving the rigidity of the wall 13 against a load input from the direction perpendicular to the thickness direction.

A content ratio may be a volume content ratio or a weight content ratio of the reinforcing fiber 2 or the flame retardant 3 in each layer of the wall 13 or at each position in the thickness direction of the wall 13. The volume content ratio is the ratio of the volume of the particles of the reinforcing fiber 2 or the flame retardant 3 to the volume of any selected part of the wall 13. The weight content ratio is the ratio of the weight of the particles of the reinforcing fiber 2 or the flame retardant 3 to the weight of any selected part of the wall 13.

The volume content ratio may be measured by cross-sectional observation using, for example, scanning electron microscope (SEM) or energy dispersive X-ray spectroscopy (EDX). For example, any selected portion of the wall 13 is cut in the thickness direction to form a cross section. Then, the volume content ratio of the reinforcing fiber 2 or the flame retardant 3 may be calculated based on the ratio of the reinforcing fiber 2 or the flame retardant 3 in the image of the cross section. The weight content ratio may be calculated, based on the volume content ratio, and the specific gravity of the reinforcing fiber 2 or the flame retardant 3. Further, the volume content ratio or the weight content ratio may be obtained by slicing an any selected portion of the wall 13 in a direction perpendicular to the thickness direction and dividing the sliced portion into a plurality of layers, and calculating the ratio of the reinforcing fiber 2 or the flame retardant 3 contained in each of the plurality of layers. For example, each of the plurality of layers is heated, or immersed in an organic solvent to remove resin components. Then, by obtaining the volume or the weight of the reinforcing fiber 2 or the flame retardant 3 contained in each of the plurality of layers, the volume content ratio or the weight content ratio of the reinforcing fiber 2 or the flame retardant 3 in each of the plurality of layers may be calculated.

### First Embodiment

Next, the structure of the battery pack 1 according to a first embodiment will be described with reference to FIGS. 4 to 6. As illustrated in FIG. 4, the gas release portion 25 may be provided in the upper portion of the battery cell 22. The housing 10 illustrated in FIG. 4 has an opposing wall 17 as a wall 13. The opposing wall 17 is a wall that is opposed to at least the gas release portion 25 in the direction in which gas is released from the gas release portion 25. In the illustrated example, when gas is generated inside the battery cell 22, the gas is released upward as indicated by arrow A in the figure. Therefore, the opposing wall 17 forms at least a part of the upper cover 11. The opposing wall 17 may have a substantially rectangular shape extending in the vehicle width direction in plan view, and multiple opposing walls 17 may be provided in the upper cover 11 (see FIG. 1).

In the battery pack 1 illustrated in the figures, the plurality of battery cells 22 are arranged in parallel in the vehicle width direction (see FIGS. 2 and 3), and the plurality of gas release portions 25 are arranged in a substantially linear formation in the vehicle width direction. Therefore, the opposing wall 17 may extend from the left end to the right end of the wall 13a in the vehicle width direction so as to cover the plurality of gas release portions 25. However, the shape of the opposing wall 17 is not limited to the illustrated example, and may be appropriately set according to, for example, the position of the gas release portions 25, or the shape or dimensions of the battery pack 1.

The first layer 14 illustrated in the figure forms the inner layer 14a. The inner layer 14a is a portion of the opposing wall 17 on the battery cell 22 side. The second layer 15 forms the outer layer 15a. That is, the outer layer 15a forms a portion of the opposing wall 17 opposite to the inner layer 14a in the thickness direction of the opposing wall 17. The outer layer 15a may form at least a part of the exterior surface of the housing 10.

In the opposing wall 17, the inner layer 14a is set to have a relatively high content ratio of the reinforcing fiber 2. Therefore, the strength of the inner layer 14a is set relatively high, and thus the opposing wall 17 is more reliably reinforced by the inner layer 14a. Hereinafter, such a layer that is formed for reinforcing the wall 13 as one of the main purposes is simply referred to as a reinforcing layer. The reinforcing fiber 2 contained in the inner layer 14a may include continuous fibers oriented toward the longitudinal direction of the opposing wall 17. In the illustrated example, the vehicle width direction corresponds to the longitudinal direction of the opposing wall 17.

Further, in the opposing wall 17 illustrated in the figure, the outer layer 15a is set to have a relatively high content ratio of the flame retardant 3. Therefore, the flame retardancy can be more reliably imparted to the opposing wall 17 by the outer layer 15a. Hereinafter, a layer that is formed for imparting such flame retardancy as one of the main purposes is simply referred to as a flame retardant layer.

Next, an example of changes in the content ratios of the reinforcing fiber 2 and the flame retardant 3 in the opposing wall 17 in the thickness direction will be described with reference to FIGS. 5 and 6. As in the configuration illustrated in the figures, the inner layer 14a functions as a reinforcing layer. In addition, the outer layer 15a functions as a flame retardant layer.

The horizontal axis of the graph illustrated in FIGS. 5 and 6 represents each position in the thickness direction of the opposing wall 17. The horizontal-axis positive direction corresponds to the upper side of the opposing wall 17, and the horizontal-axis negative direction corresponds to the lower side of the opposing wall 17. The vertical axis of the graph represents the content ratio of the reinforcing fiber 2 or the flame retardant 3 in each portion of the opposing wall 17. In the illustrated example, the content ratio of the reinforcing fiber 2 at each position in the thickness direction is indicated by a solid line, and the content ratio of the flame retardant 3 at each position in the thickness direction is indicated by a dashed line.

In the example illustrated in the graph of FIG. 5, the content ratio of the reinforcing fiber 2 of the opposing wall 17 is set so as to increase downward. Therefore, the content ratio of the reinforcing fiber 2 of the inner layer 14a is higher than the content ratio of the reinforcing fiber 2 of the outer layer 15a. Further, the content ratio of the flame retardant 3 of the opposing wall 17 is set so as to increase upward. Therefore, the content ratio of the flame retardant 3 of the inner layer 14a is lower than the content ratio of the flame retardant 3 of the outer layer 15a.

In the example illustrated in the graph of FIG. 6, the content ratios of the reinforcing fiber 2 and the flame retardant 3 are set to increase or decrease discontinuously in a stepwise manner between the inner layer 14a and the outer layer 15a. Further, the content ratios of the reinforcing fiber 2 and the flame retardant 3 in each of the inner layer 14a and the outer layer 15a are approximately constant in the thickness direction. The content ratio of the reinforcing fiber 2 of the inner layer 14a illustrated in the figure is higher than the content ratio of the reinforcing fiber 2 of the outer layer 15a. Further, the content ratio of the flame retardant 3 of the inner layer 14a is lower than the content ratio of the flame retardant 3 of the outer layer 15a.

### Second Embodiment

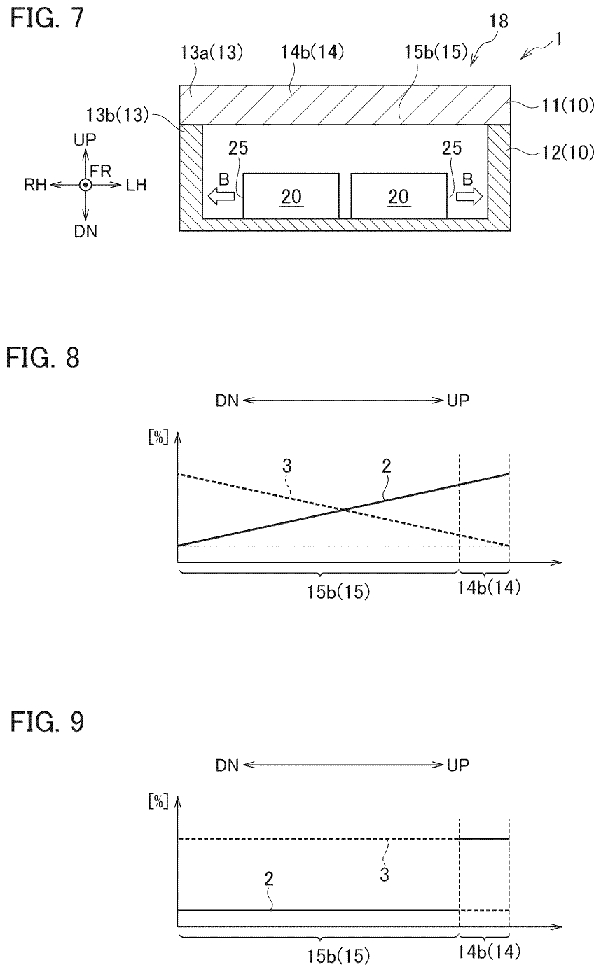

Next, the structure of the battery pack 1 according to a second embodiment will be described with reference to FIGS. 7 to 9. In the present embodiment, as illustrated in FIG. 7, the gas release portion 25 is provided on the lateral side of the battery cell 22. The housing 10 illustrated in the figure has a first wall 18 as the wall 13. The first wall is not opposed to the gas release portion 25. That is, the first wall 18 is a portion of the housing 10 other than the opposing wall 17. In the illustrated example, when gas is generated inside the battery cell 22, the gas is released to the left side of the vehicle or the right side of the vehicle as indicated by arrow B in the figure. At this time, since the first wall 18 is not opposed to the gas release portion 25, the jet of the gas does not directly collide with the first wall 18. The first wall 18 may form at least a part of the upper cover 11.

In the illustrated example, an outer layer 14b as the first layer 14 forms an outer portion of the wall 13. That is, the outer layer 14b forms a portion of the first wall 18 opposite to the portion on the battery cell 22 side. The outer layer 14b may form at least a part of the exterior surface of the housing 10. The outer layer 14b may form an upper portion of the upper cover 11. Further, in the illustrated example, an inner layer 15b as the second layer 15 forms an inner portion of the wall 13. Therefore, the inner layer 15b may define at least a part of the inner space of the housing 10. The inner layer 15b may form a lower portion of the upper cover 11.

In the first wall 18 illustrated in FIG. 7, the outer layer 14b is set to have a relatively high content ratio of the reinforcing fiber 2. Therefore, the strength of the outer layer 14b is set relatively high, and thus the first wall 18 is more reliably reinforced by the outer layer 14b. Further, in the first wall 18 illustrated in the figure, the inner layer 15b is set to have a relatively high content ratio of the flame retardant 3. Therefore, the flame retardancy can be imparted to the first wall 18 by the inner layer 15b more reliably.

Next, an example of changes in content ratios of the reinforcing fiber 2 and the flame retardant 3 in the first wall 18 in the thickness direction will be described with reference to FIGS. 8 and 9. As in the configuration illustrated in the figures, the outer layer 14b functions as a reinforcing layer. In addition, the inner layer 15b functions as a flame retardant layer.

The horizontal axis of the graph illustrated in FIGS. 8 and 9 represents each position in the thickness direction of the first wall 18. The horizontal-axis positive direction corresponds to the upper side of the first wall 18, and the horizontal-axis negative direction corresponds to the lower side of the first wall 18. The vertical axis of the graph represents the content ratio of the reinforcing fiber 2 or the flame retardant 3 in each portion of the first wall 18. In the illustrated example, the content ratio of the reinforcing fiber 2 at each position in the thickness direction is indicated by a solid line, and the content ratio of the flame retardant 3 at each position in the thickness direction is indicated by a dashed line.

In the example illustrated in the graph of FIG. 8, the content ratio of the reinforcing fiber 2 of the first wall 18 is set so as to increase upward. Therefore, the content ratio of the reinforcing fiber 2 of the outer layer 14b is higher than the content ratio of the reinforcing fiber 2 of the inner layer 15b. Further, the content ratio of the flame retardant 3 of the first wall 18 is set so as to increase downward. Therefore, the content ratio of the flame retardant 3 of the outer layer 14b is lower than the content ratio of the flame retardant 3 of the inner layer 15b.

In the example illustrated in the graph of FIG. 9, the content ratios of the reinforcing fiber 2 and the flame retardant 3 are set to increase or decrease discontinuously in a stepwise manner between the outer layer 14b and the inner layer 15b. Further, the content ratios of the reinforcing fiber 2 and the flame retardant 3 in each of the outer layer 14b and the inner layer 15b are approximately constant in the thickness direction. The content ratio of the reinforcing fiber 2 of the outer layer 14b illustrated in the figure is higher than the content ratio of the reinforcing fiber 2 of the inner layer 15b. Further, the content ratios of the flame retardant 3 of the outer layer 14b is lower than the content ratio of the flame retardant 3 of the inner layer 15b.

### Third Embodiment

Next, the structure of the battery pack 1 according to a third embodiment will be described with reference to FIGS. 10 to 12, taking the wall 13a of the upper cover 11 as an example. In the present embodiment, the wall 13a includes the first layer 14, the second layer 15, and the third layer 16. In the illustrated example, the first layer 14 forms an inner layer 14c. The inner layer 14c is a portion of the wall 13a constituting the inner side of the housing 10. That is, the inner layer 14c forms a portion of the wall 13a on the battery cell 22 side. The second layer 15 forms a first outer layer 15c. The first outer layer 15c is formed on the upper side of the inner layer 14c in the thickness direction of the wall 13a. The third layer 16 forms a second outer layer 16c. The second outer layer 16c is formed on the upper side of the first outer layer 15c in the thickness direction of the wall 13a.

A positional relationship of the first layer 14, the second layer 15, and the third layer 16 in the wall 13a is not limited to the illustrated example. For example, the wall 13a may be configured with the up-down direction illustrated in the figure reversed, that is, the second outer layer 16c may form the first layer 14, the first outer layer 15c may form the second layer 15, and the inner layer 14c may form the third layer 16. In this case, the third layer 16 corresponds to the first layer 14. Further, although the second layer 15 and the third layer 16 are directly adjacent to each other in the illustrated example, an intermediate layer may be interposed between the second layer 15 and the third layer 16. That is, the second layer 15 and the third layer 16 may be directly or indirectly adjacent to each other.

In the wall 13a, the inner layer 14c as the first layer 14 and the second outer layer 16c as the third layer 16 are set to have a relatively high content ratio of the reinforcing fiber 2. Therefore, the inner layer 14c and the second outer layer 16c function as reinforcing layers. Further, in the wall 13a, the first outer layer 15c as the second layer 15 is set to have a relatively high content ratio of the flame retardant 3. Therefore, the first outer layer 15c functions as a flame retardant layer. The wall 13a according to the present embodiment may be the opposing wall 17 or the first wall 18. Further, when the opposing wall 17 is configured as the wall 13a according to the present embodiment, at least one of the inner layer 14c and the second outer layer 16c may contain continuous fibers oriented toward the longitudinal direction of the opposing wall 17 as the reinforcing fiber 2.

The horizontal axis of the graph illustrated in FIGS. 11 and 12 represents each position in the thickness direction of the wall 13a. The horizontal-axis positive direction corresponds to the upper side of the wall 13a, and the horizontal-axis negative direction corresponds to the lower side of the wall 13a. The vertical axis of the graph represents the content ratio of the reinforcing fiber 2 or the flame retardant 3 in each portion of the wall 13a. In the illustrated example, the content ratio of the reinforcing fiber 2 at each position in the thickness direction is indicated by a solid line, and the content ratio of the flame retardant 3 at each position in the thickness direction is indicated by a dashed line.

In the example illustrated in the graph of FIG. 11, the content ratio of the reinforcing fiber 2 of the wall 13a is set so as to decrease toward the vicinity of the central portion in the thickness direction of the wall 13a. Therefore, the content ratio of the reinforcing fiber 2 of each of the inner layer 14c and the second outer layer 16c is higher than the content ratio of the reinforcing fiber 2 of the first outer layer 15c. The change of the content ratio of the reinforcing fiber 2 in the thickness direction is not limited to the illustrated example. For example, the content ratio may be minimum in the region on the inner layer 14c side or in the region on the second outer layer 16c side, not in the vicinity of the central portion in the thickness direction of the wall 13a.

Further, the content ratio of the flame retardant 3 of the wall 13a is set so as to increase toward the vicinity of the central portion in the thickness direction of the wall 13a. Therefore, the content ratio of the flame retardant 3 of each of the inner layer 14c and the second outer layer 16c is lower than the content ratio of the flame retardant 3 of the first outer layer 15c. The change of the content ratio of the flame retardant 3 in the thickness direction is not limited to the illustrated example. For example, the content ratio may be maximum in the region on the inner layer 14c side or in the region the second outer layer 16c side, not in the vicinity of the central portion in the thickness direction of the wall 13a.

In the example illustrated in the graph of FIG. 12, the content ratios of the reinforcing fiber 2 and the flame retardant 3 are set to increase or decrease discontinuously in a stepwise manner between the inner layer 14c and the first outer layer 15c, and between the first outer layer 15c and the second outer layer 16c. In addition, the content ratios of the reinforcing fiber 2 and the flame retardant 3 in each of the inner layer 14c, the first outer layer 15c, and the second outer layer 16c are approximately constant in the thickness direction. The content ratio of the reinforcing fiber 2 of the inner layer 14c illustrated in the figure is higher than the content ratio of the reinforcing fiber 2 of the first outer layer 15c. The content ratio of the flame retardant 3 of the inner layer 14c is lower than the content ratio of the flame retardant 3 of the first outer layer 15c. Further, the content ratio of the reinforcing fiber 2 of the second outer layer 16c is higher than the content ratio of the reinforcing fiber 2 of the first outer layer 15c. The content ratio of the flame retardant 3 of the second outer layer 16c is lower than the content ratio of the flame retardant 3 of the first outer layer 15c.

In the examples illustrated in FIGS. 11 and 12, a magnitude relationship between the content ratio of the reinforcing fiber 2 and the content ratio of the flame retardant 3 of each of the inner layer 14c and the second outer layer 16c is not particularly limited. For example, the content ratio of the reinforcing fiber 2 of the inner layer 14c and the content ratio of the reinforcing fiber 2 of the second outer layer 16c may be approximately equal to each other. In addition, the content ratio of the flame retardant 3 of the inner layer 14c and the content ratio of the flame retardant 3 of the second outer layer 16c may be approximately equal to each other.

The mode in which the content ratios of the reinforcing fiber 2 and the flame retardant 3 increase or decrease in the thickness direction is not limited to the examples illustrated in FIGS. 5, 8, and 11. The content ratios may increase or decrease linearly, or increase or decrease in a curvilinear manner. Further, the content ratios may increase or decrease gradually. For example, the wall 13 may include a layer in which the content ratio of the reinforcing fiber 2 decreases from the first layer 14 toward the second layer 15 in the thickness direction of the wall 13, and the content ratio of the flame retardant 3 increases from the first layer 14 toward the second layer 15 in the thickness direction of the wall 13. In one embodiment, the wall 13 may include a layer in which the content ratio of each of the reinforcing fiber 2 and the flame retardant 3 increases or decreases gradually in the thickness direction of the wall 13. In the example illustrated in FIG. 5, the opposing wall 17 includes a layer in which the content ratio of the reinforcing fiber 2 decreases upward from the lower portion of the inner layer 14a and the content ratio of the flame retardant 3 increases upward from the lower portion of the inner layer 14a. In the example illustrated in FIG. 8, the first wall 18 includes a layer in which the content ratio of the reinforcing fiber 2 decreases downward from the upper portion of the outer layer 14b and the content ratio of the flame retardant 3 increases downward from the upper portion of the outer layer 14b. In the example illustrated in FIG. 10, the wall 13a includes a layer in which the content ratio of the reinforcing fiber 2 decreases upward from the lower portion of the inner layer 14c and the content ratio of the flame retardant 3 increases upward from the lower portion of the inner layer 14c. That is, the wall 13 may include a layer in which the content ratio of the reinforcing fiber 2 decreases from a portion of the first layer 14 on one side toward the other side of the first layer 14 in the thickness direction of the wall 13 and the content ratio of the flame retardant 3 increases from a portion of the first layer 14 on one side toward the other side of the first layer 14 in the thickness direction of the wall 13.

For example, if an intermediate layer is included between the first layer 14 and the second layer 15, the content ratios of the reinforcing fiber 2 and the flame retardant 3 may gradually increase or decrease from the first layer 14 to the second layer 15. That is, the content ratio of the reinforcing fiber 2 may gradually decrease from the first layer 14 to the second layer 15. In addition, the content ratio of the flame retardant 3 may gradually increase from the first layer 14 to the second layer 15.

In the examples illustrated in FIGS. 5, 8, and 11, the content ratios of the reinforcing fiber 2 and the flame retardant 3 generally increase or decrease gradually and smoothly in the up-down direction; however, the present invention is not limited thereto. The change in the content ratios may be discontinuous. For example, in the example illustrated in FIG. 6, the content ratio of the reinforcing fiber 2 is kept approximately constant in the thickness direction of the inner layer 14a, decreases relatively largely in the portion of the outer layer 15a on the inner layer 14a side, and is kept approximately constant in the thickness direction of the outer layer 15a. That is, the content ratio decreases from the inner layer 14a to the outer layer 15a in a stepwise manner. Similarly, in the example illustrated in FIG. 9, the content ratio of the reinforcing fiber 2 increases from the inner layer 15b to the outer layer 14b in a stepwise manner. In the example illustrated in FIG. 12, the content ratio of the reinforcing fiber 2 decreases from the inner layer 14c to the first outer layer 15c in a stepwise manner, and increases from the first outer layer 15c to the second outer layer 16c in a stepwise manner. Thus, the wall 13 may include a region in which the content ratio of the reinforcing fiber 2 increases or decreases in the thickness direction of the wall 13 in a stepwise manner. Similarly, the wall 13 may include a region in which the content ratio of the flame retardant 3 increases or decreases in the thickness direction of the wall 13 in a stepwise manner. That is, the content ratio of each of the reinforcing fiber 2 and the flame retardant 3 may increase or decrease stepwise in the thickness direction of the wall 13. Here, the “increasing or decreasing stepwise” means, for example, that the content ratio increases or decreases in a stepwise manner while the content ratio is kept constant in a predetermined section. That is, the mode in which the content ratio of each of the reinforcing fiber 2 and the flame retardant 3 may increase or decrease discretely in the thickness direction of the wall 13.

Next, a formation method of the wall 13 of the battery pack 1 according to the embodiment will be described. For example, as illustrated in FIG. 5, the wall 13 in which the content ratios of the reinforcing fiber 2 and the flame retardant 3 gradually change in the thickness direction may be molded by resin transfer molding (RTM). In RTM, the wall 13 is molded by injecting resin into a mold in which preforms, which are base materials that include the reinforcing fiber 2, are laminated and placed, followed by heating and pressurizing the resin. When increasing the content ratio of the reinforcing fiber 2 toward the lower side of the wall 13, multiple kinds of preforms are laminated and arranged inside the mold such that the density of the reinforcing fiber 2 increases toward the lower side thereof. For example, the preforms arranged on the lower side may be non-crimp fabric (NCF) and the preforms arranged on the upper side may be woven fabric. The flame retardant 3 may be previously added to the resin to be injected into the inside of the mold. When such resin is injected into the mold, the density of the flame retardant 3 increases on the upper side of the mold and decreases on the lower side thereof, following the change in the density of the laminated preforms. Thereafter, the wall 13 containing the reinforcing fiber 2 and the flame retardant 3 is integrally molded by heat and pressure molding. The formation method of the wall 13 is not limited to RTM, and a known method such as vacuum assisted resin transfer molding (VaRTA) may be used as appropriate.

In addition, the wall 13 may be formed by press-molding a sheet-like base material. For example, as illustrated in FIG. 6, the wall 13, in which the content ratios of the reinforcing fiber 2 and the flame retardant 3 change discontinuously in the thickness direction, may be formed by laminating and placing base materials containing the reinforcing fiber 2 and the flame retardant 3 inside the mold of a press machine, followed by heat and pressure molding. The base materials are molded into a sheet shape by adding the reinforcing fiber 2 and the flame retardant 3 to resin beforehand. The base materials may be, for example, sheet molding compound (SMC) in which the flame retardant 3 is previously added. When the content ratios of the reinforcing fiber 2 and the flame retardant 3 are set as illustrated in FIG. 6, a base material having a relatively high content ratio of the reinforcing fiber 2 and a relatively low content ratio of the flame retardant 3 is placed on the lower side inside the mold. Then, a base material having a relatively low content ratio of the reinforcing fiber 2 and a relatively high content ratio of the flame retardant 3 is placed on top of the first base material. Thereafter, the wall 13 containing the reinforcing fiber 2 and the flame retardant 3 is integrally molded by heat and pressure molding.

The operation and effects of the battery pack structure for a vehicle according to the embodiments will be described below.
(1) The battery pack structure for a vehicle according to the embodiments includes the housing 10 that is configured to house the battery 22, and the wall 13 that is configured to form at least a part of the housing 10 and cover the battery 22. The wall 13 includes the first layer 14 that is configured to form a portion of the wall 13 on one side in the thickness direction of the wall 13, and the second layer 15 that is formed on the other side of the first layer 14 in the thickness direction of the wall 13. The first layer 14 and the second layer 15 contain the reinforcing fiber 2 and the flame retardant 3. A content ratio of the reinforcing fiber 2 of the first layer 14 in the first layer 14 is higher than a content ratio of the reinforcing fiber 2 of the second layer 15 in the second layer 15. A content ratio of the flame retardant 3 of the first layer 14 in the first layer 14 is lower than a content ratio of the flame retardant 3 of the second layer 15 in the second layer 15.

In the battery pack structure for a vehicle according to the embodiments, the wall 13 of the housing 10 includes the reinforcing fiber 2 and the flame retardant 3. The wall 13 also includes at least the first layer 14 having a relatively high content ratio of the reinforcing fiber 2. This improves the rigidity of the housing 10. Therefore, the rigidity of the housing against an increase in the internal pressure of the housing 10 when the battery cell 22 releases gas can be improved. Further, the wall 13 includes at least the second layer 15 having a relatively high content ratio of the flame retardant 3. This improves the heat resistance of the housing 10, thereby protecting the housing 10 more reliably from the heat of the gas released from the battery cell 22.
(2) The battery 22 may have the gas release portion 25 that is configured to release gas. The wall 13 is the opposing wall 17 that is opposed to at least the gas release portion 25 in the direction in which the gas is released, and the first layer 14 may form the inner layer 14a of the opposing wall 17 on the battery 22 side.

Thus, the gas generated in the battery cell 22 is released from the gas release portion 25 toward the opposing wall 17. Here, the inner layer 14a of the opposing wall 17 is composed of the first layer 14 functioning as a reinforcing layer. Therefore, the dynamic pressure of the released gas is input to the first layer 14 having high rigidity. This makes it possible to further improve the rigidity of the housing 10 against the dynamic pressure. Further, a content ratio of the flame retardant 3 is set higher in the outer layer 15a than in the inner layer 14a. Therefore, even if the region in the vicinity of the first layer 14 may be worn by the colliding jet of the gas, the housing 10 can be more reliably protected from the heat of the gas while reducing the amount of the flame retardant 3 used in the region.
(3) The battery 22 may have the gas release portion 25 that is configured to release gas. The wall 13 is a portion 18 of the housing 10 other than the opposing wall 17 that is opposed to at least the gas release portion 25 in the direction in which the gas is released, and the first layer 14 may form the outer layer 14b of the portion 18 other than the opposing wall, the outer layer 14b being on a side opposite to the battery 22 side.

When the pressure in the housing 10 increases due to the release of gas, there is a possibility that tensile stress is input to the outer layer 14b. However, since the outer layer 14b includes the first layer 14, the rigidity of the outer layer 14b against tensile stress is set higher. This makes it possible to protect the housing 10 more reliably from an increase in internal pressure caused by the release of the gas. Further, a content ratio of the flame retardant 3 is set relatively high in the inner layer 15b of the first wall 18. Therefore, even if the heat of the gas is transmitted to the first wall 18, the housing 10 can be more reliably protected from the heat.
(4) The wall 13 may include a layer in which a content ratio of the reinforcing fiber 2 decreases from the first layer 14 toward the second layer 15 in the thickness direction of the wall 13 and a content ratio of the flame retardant 3 increases from the first layer 14 toward the second layer 15 in the thickness direction of the wall 13.

Thus, the content ratio of each of the reinforcing fiber 2 and the flame retardant 3 contained in the wall 13 gradually changes in the thickness direction of the wall 13. Therefore, for example, when a load perpendicular to the thickness direction thereof is input to the wall 13, the rigidity of the wall 13 against the load can be further improved.
(5) The content ratio of each of the reinforcing fiber 2 and the flame retardant 3 in the wall 13 may increase or decrease stepwise in the thickness direction of the wall 13.

This makes it possible to control changes in content ratios of the reinforcing fiber 2 and the flame retardant 3 in the thickness direction of the wall 13 more easily. Therefore, the battery pack structure for a vehicle according to the embodiment can be more easily configured.

### REFERENCE SIGNS LIST

1 Battery pack (battery pack structure for vehicle)
2 Reinforcing fiber
3 Flame retardant
10 Housing
13, 13a, 13b Wall
14 First layer
14a Inner layer
14b Outer layer
15 Second layer
17 Opposing wall
18 First wall (portion other than opposing wall)
22 Battery cell (battery)
25 Gas release portion

1. A battery pack structure for a vehicle comprising:
a housing that is configured to house a battery; and
a wall that is configured to form at least a part of the housing and cover the battery; wherein
the wall includes a first layer that is configured to form a portion of the wall on one side in a thickness direction of the wall, and a second layer that is formed on the other side of the first layer in the thickness direction of the wall,
the first layer and the second layer each contain a reinforcing fiber and a flame retardant,
a content ratio of the reinforcing fiber of the first layer in the first layer is higher than a content ratio of the reinforcing fiber of the second layer in the second layer, and
a content ratio of the flame retardant of the first layer in the first layer is lower than a content ratio of the flame retardant of the second layer in the second layer.

2. The battery pack structure for a vehicle according to claim 1, wherein
the battery has a gas release portion that is configured to release gas,
the wall is an opposing wall that is opposed to at least the gas release portion in a direction in which the gas is released, and
the first layer forms an inner layer of the opposing wall on a battery side.

3. The battery pack structure for a vehicle according to claim 1, wherein
the battery has a gas release portion that is configured to release gas,
the wall is a portion of the housing other than an opposing wall that is opposed to at least the gas release portion in a direction in which the gas is released, and
the first layer forms an outer layer of the portion other than the opposing wall, the outer layer being on a side opposite to a battery side.

4. The battery pack structure for a vehicle according to claim 1, wherein the wall includes a layer in which the content ratio of the reinforcing fiber decreases from the first layer toward the second layer in the thickness direction of the wall and the content ratio of the flame retardant increases from the first layer toward the second layer in the thickness direction of the wall.

5. The battery pack structure for a vehicle according to claim 1, wherein the content ratio of each of the reinforcing fiber and the flame retardant in the wall increases or decreases stepwise in the thickness direction of the wall.
